(19) United States
(12) Patent Application Publication
(10) Pub. No.: US 2012/0105893 A1
(43) Pub. Date: May 3, 2012

(54) IMAGE PROCESSING APPARATUS, CONTROL METHOD FOR IMAGE PROCESSING APPARATUS AND PROGRAM

(75) Inventor: Akio Ito, Yokohama-shi (JP)

(73) Assignee: CANON KABUSHIKI KAISHA, Tokyo (JP)

(21) Appl. No.: 13/375,129

(22) PCT Filed: Sep. 29, 2011
(86) PCT No.: PCT/JP2011/073034

§ 371 Date: Nov. 29, 2011

(30) Foreign Application Priority Data
Oct. 12, 2010 (JP) 2010-230104

(51) Int. Cl. G06K 15/02

(52) U.S. Cl. 358/1.13

(57) ABSTRACT

An image processing apparatus according to the present invention, being capable of communicating with an operation panel provided with a display unit, obtains, from the operation panel, information indicating a display layout for data that is displayed on the display unit. The display layout is set by a direction of the operation panel. The image processing apparatus then generates image data in accordance with the display layout, based on the obtained information, and outputs the generated image data.

### TECHNICAL FIELD

The present invention relates to an image processing apparatus, a control method for the image processing apparatus, and a program.

### BACKGROUND ART

An image forming apparatus such as a multi-function peripheral typically has connected thereto an operation panel that is integrally formed with the image forming apparatus (main body) and includes a display unit. There are also large-scale devices in which the image forming apparatus main body is equipped with different sheet discharge processing units such as a finisher and the like that, by configuring the operation panel to be detachable from the main body, enable the user to operate the operation panel while viewing operation procedures displayed on the operation panel and moving around the large-scale device.

Recently, there are small-scale computers provided with 3D acceleration sensors or the like that are provided with a function of detecting the tilt of the apparatus and switching screen display vertically or horizontally (e.g., Japanese Patent Laid-Open No. 11-30969).

In an image forming apparatus having a detachable operation panel, the user can remove the operation panel from the main body, and perform operations while viewing the operation panel. However, this merely enables the user to view the operation panel at arbitrary locations, and the difficultly lies in further improving operability.

Also, a small-scale computer provided with a 3D acceleration sensor only allows the display direction of the display unit to be changed using the sensor, and does not allow the display direction to be reflected in a print instruction from a computer to a printer, for instance.

### SUMMARY OF INVENTION

The present invention has been made in order to solve the above conventional problems. A feature of the present invention lies in providing an image processing apparatus that is able to output an image in the state visible on an operation panel, a control method therefor, and a program.

According to one aspect of the present invention, there is provided an image processing apparatus comprising: communicating means capable of communicating with an operation panel provided with a display unit; obtaining means for obtaining, from the operation panel, information indicating a display layout for data that is displayed on the display unit, the display layout being set by a direction of the operation panel; generating means for generating image data in accordance with the display layout, based on the information obtained by the obtaining means; and outputting means for outputting the image data generated by the generating means.

According to another aspect of the present invention, there is provided a control method for controlling an image processing apparatus capable of communicating with an operation panel provided with a display unit, comprising: obtaining, from the operation panel, information indicating a display layout for data that is displayed on the display unit, the display layout being set by a direction of the operation panel; generating image data in accordance with the display layout, based on the obtained information; and outputting the generated image data.

According to still another aspect of the present invention, there is provided a program for causing a computer to execute a control method for controlling an image processing apparatus capable of communicating with an operation panel provided with a display unit, the program causing the computer to function as an image processing apparatus comprising: obtaining means for obtaining, from the operation panel, information indicating a display layout for data that is displayed on the display unit, the display layout being set by a direction of the operation panel; generating means for generating image data in accordance with the display layout, based on the information obtained by the obtaining means; and outputting means for outputting the image data generated by the generating means.

According to the present invention, the operability of using the operation panel can be markedly enhanced, since an image can be output in the state visible on the operation panel.

Further features of the present invention will become apparent from the following description of exemplary embodiments (with reference to the attached drawings).

### BRIEF DESCRIPTION OF DRAWINGS

FIG. 1 is a schematic diagram showing a use environment of an image forming apparatus according to an embodiment of the present invention.

FIG. 2 is a block diagram showing control configurations of an image forming apparatus main body, a home position, and an operation panel according to the embodiment.

FIG. 3 is a flowchart illustrating processing by the operation panel according to the embodiment.

FIG. 4 is a flowchart illustrating input detection processing of S301 in FIG. 3 in detail.

FIG. 5 is a flowchart illustrating touch panel input detection processing of S402 in FIG. 4 in detail.

FIG. 6 is a flowchart illustrating program processing of S302 in FIG. 3.

FIG. 7 is a flowchart illustrating display control processing of S303 in FIG. 3 in detail.

FIG. 8 is a diagram showing example combinations of the vertical/horizontal direction of the operation panel and the vertical/horizontal layout of a single page according to the embodiment.

FIG. 9 is a diagram showing example layouts in the case where the images of two pages are displayed on a display unit of the operation panel.

FIG. 10 is a diagram showing a basic screen of the operation panel according to the embodiment.

FIG. 11 is a flowchart illustrating communication processing of S304 in FIG. 3 in detail.

FIG. 12 is a flowchart showing data processing by the image forming apparatus main body of the embodiment.

FIG. 13 is a sequence diagram showing data processing between the operation panel and the main body.

FIG. 14 is a diagram showing an example print execution screen displayed on the display unit of the operation panel.

FIG. 15 is a diagram showing example layouts in the case where two pages are displayed on an operation panel according to Embodiment 2.

FIG. 16 is a diagram in which the layout display of FIG. 15 has been rotated 180 degrees.

FIG. 17 shows an example print execution screen displayed on a display unit of the operation panel according to Embodiment 2.

FIG. 18 shows a flowchart illustrating processing by an image forming apparatus main body according to the embodiments.

### DESCRIPTION OF THE EMBODIMENTS

Embodiments of the present invention will now be described in detail with reference to the accompanying drawings. The following embodiments are not intended to limit the claims of the present invention, and not all combinations of features described in the embodiments are essential for the present invention. Note that while an image forming apparatus (image processing apparatus) is described as an example in the embodiments, the present invention is not limited thereto.

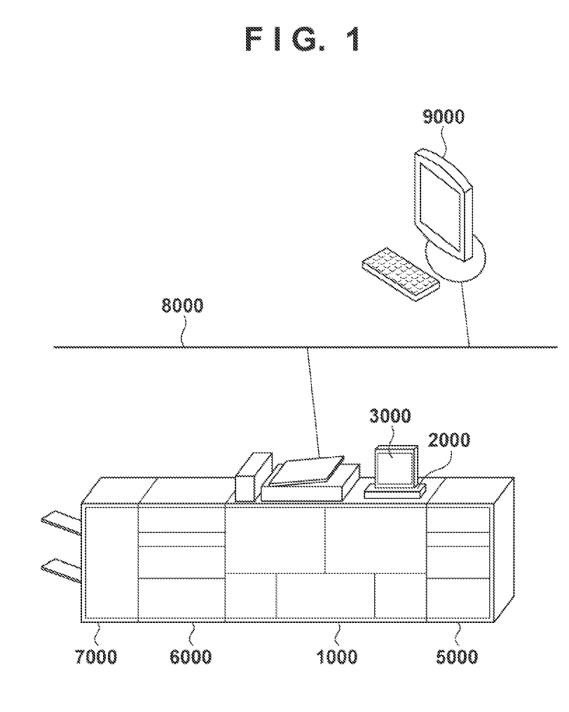

FIG. 1 is a schematic diagram showing a use environment of an image forming apparatus according to an embodiment of the present invention.

The image forming apparatus (image processing apparatus) is a so-called print-on-demand (POD) device, and can respond to requests for a diverse range of printing, bookbinding and the like, by combining various options that enable saddle stitching, cutting, folding and the like to be performed.

In FIG. 1, an example is shown in which a sheet deck 5000, a binder 6000 and a finisher 7000 are combined in an image forming apparatus main body 1000 to constitute the image forming apparatus (image processing apparatus). The main body 1000 is connected to a personal computer 9000 via a LAN 8000. The personal computer 9000 creates and edits each page of document data, and generates a print job that includes settings for binding, cutting, folding and the like. The print job thus generated is sent to the image forming apparatus main body 1000 via the LAN 8000 to be executed.

Also, in FIG. 1, a detachable operation panel 3000, which is a feature of the present embodiment, is mounted in a home position 2000 installed on the main body 1000. This detachable operation panel 3000 has a display unit, and a battery is incorporated therein so as to enable operation even when removed from the main body 1000. The operation panel 3000 is configured so that, when mounted in the home position 2000, the battery is charged by power supplied from the home position 2000.

Note that because options such as the sheet deck 5000, the binder 6000 and the finisher 7000 do not directly relate to the present invention, a detailed description thereof is omitted.

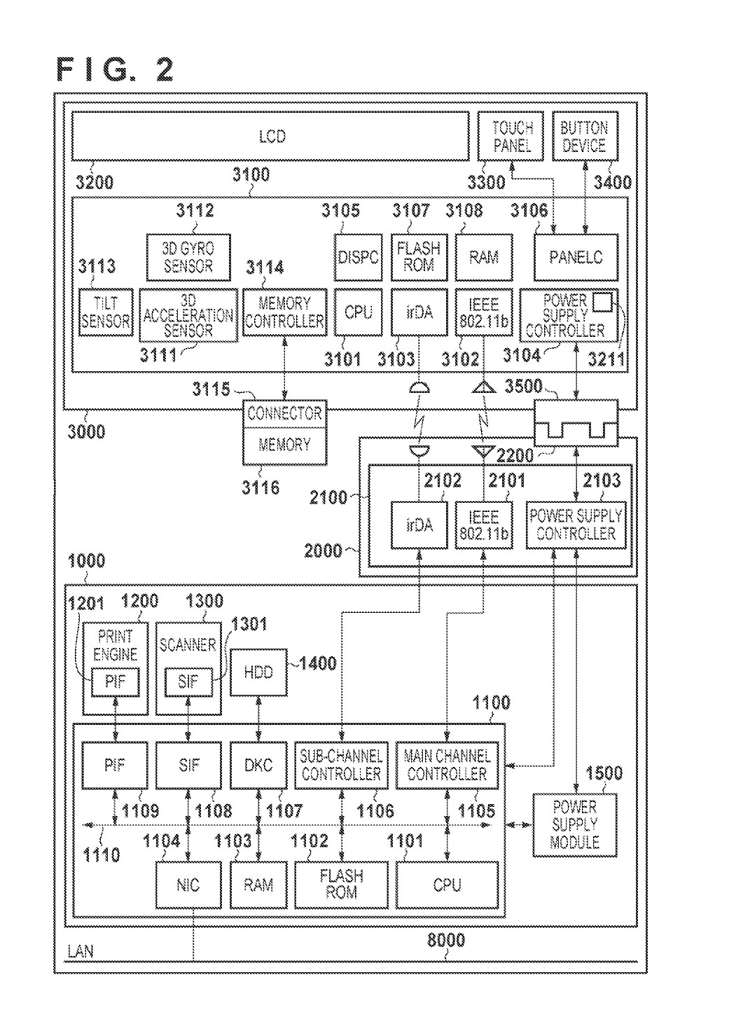

FIG. 2 is a block diagram showing control configurations of the image forming apparatus main body 1000, the home position 2000 and the operation panel 3000 according to the present embodiment. The configuration of each of the main body 1000, the home position 2000 and the operation panel 3000 will now be described. First, the main body 1000 will be described.

As shown in FIG. 2, the main body 1000 has a controller board 1100, a print engine 1200, a scanner 1300, a hard disk drive (HDD) 1400, and a power supply module 1500. These units are operated by power supplied from the power supply module 1500.

The controller board 1100 has the CPU 1101, a flash ROM 1102, a RAM 1103, a network interface card (NIC) 1104, a main channel controller 1105, and a sub-channel controller 1106. The controller board 1100 is further provided with a disk controller (DKC) 1107, a scanner interface (SIF) 1108, and a printer interface (PIF) 1109. Each of these devices 1102 to 1109 is connected to the CPU 1101 via a bus 1110.

The CPU 1101 is a processor that performs overall control of the devices connected to the bus 1110, and executes control programs stored in the flash ROM 1102 and the HDD 1400. The RAM 1103 is used as a main memory and work area of the CPU 1101. The NIC 1104 exchanges data bidirectionally with the personal computer 9000 and other imaging forming apparatuses via the LAN 8000. The HDD 1400 is accessed via the DKC 1107, and is also used as a temporary storage location for image data in addition to storing control programs.

The scanner 1300 is provided with a reading sensor, an original conveyance mechanism and the like (all of which are not shown). The reading sensor, the original conveyance mechanism and the like are controlled based on programs executed by the CPU 1101, via the SIF 1108 installed in the controller board 1100 and the SIF 1301 installed in the scanner 1300. As a result, the scanner 1300 reads an original using the reading sensor, and transfers the obtained data to the controller board 1100 via the SIF 1301 and the SIF 1108.

The print engine 1200 is provided with an electrophotographic recording unit, a recording sheet cassette, a sheet conveyance unit, and the like (all of which are not shown). A print request based on a print job is sent from the controller board 1100 via the PIF 1109 and a PIF 1201 installed in the print engine 1200. The recording unit, the sheet conveyance unit and the like provided in the print engine 1200 are similarly controlled based on programs executed by the CPU 1101 via the PIF 1109 and the PIF 1201. As a result, the print engine 1200 forms an image corresponding to the print request on a sheet.

The main channel controller 1105 and the sub-channel controller 1106 are used during the exchange of data between the main body 1000 and the detachable operation panel 3000. This will be discussed in detail later.

Next, the home position 2000 will be described.

As shown in FIG. 2, the home position 2000 is primarily provided with a main board 2100 and a connector 2200. The main board 2100 is further provided with an IEEE 802.11b module 2101, an irDA module 2102, and a power supply controller 2103. The IEEE 802.11b module 2101 is connected to the main channel controller 1105 of the controller board 1100. The IEEE 802.11b module 2101 mediates communication between the controller board 1100 and the operation panel 3000, by establishing wireless communication with an IEEE 802.11b module 3102 of the operation panel 3000, based on a request from the controller board 1100. The irDA module 2102 is connected to the sub-channel controller 1106 of the controller board 1100. The irDA module 2102 mediates communication between the controller board 1100 and the operation panel 3000, by establishing infrared communication with an irDA module 3103 of the operation panel 3000, based on a request from the operation panel controller board 1100. The power supply controller 2103 is connected to the power supply module 1500. The IEEE 802.11b module 2101 and the irDA module 2102 receive power from the power supply module 1500 via the power supply controller 2103. The power supply controller 2103 is also connected to the connector 2200, and supplies power to the operation panel 3000 when a connector 3500 of the operation panel 3000 and the connector 2200 are in a contact state. In addition, the power supply controller 2103 monitors the state of power supply, detects whether the operation panel 3000 is in a state of being mounted in the home position 2000, and transmits the detection result to the controller board 1100.

Next, the operation panel 3000 will be described.

The detachable operation panel 3000 is primarily equipped with a main board 3100, a display unit (liquid crystal display (LCD)) 3200, a touch panel 3300, a button device 3400, and the connector 3500. The main board 3100 has a CPU 3101, the IEEE 802.11b module 3102, the irDA module 3103, and a power supply controller 3104. The main board 3100 further has a display controller (DISPC) 3105, a panel controller (PANELC) 3106, a flash ROM 3107, and a RAM 3108. The modules 3101 to 3108 are interconnected by a bus (not shown), similarly to the controller board 1100.

The CPU 3101 is a processor that performs overall control of the devices connected to the bus, and executes control programs stored in the flash ROM 3107. The RAM 3108 functions as a main memory and work area of the CPU 3101, and as a storage area for video data that will be displayed on the LCD 3200. The CPU 3101 is able to recognize the posture and motion of the operation panel 3000 using a three-dimensional (3D) acceleration sensor 3111 and a three-dimensional (3D) gyro sensor 3112. The 3D acceleration sensor 3111 has a movable portion within a semiconductor chip, and fins of the movable portion move due to acceleration applied from outside, changing the interval between the fins and a non-moving portion, resulting in a change in capacitance. Acceleration applied to the operation panel 3000 from outside can thereby be detected. The 3D gyro sensor 3112 is a semiconductor device of a type utilizing Coriolis force. The CPU 3101, by signal processing the output of these two sensors 3111 and 3112 taking into account the effect of gravity, is able to detect whether the operation panel 3000 is in an upright state or in a flat state and whether it is in portrait or landscape direction, and also accurately detect three-dimensional motion of the operation panel 3000 in the front-back, up-down and left-right directions.

Note that apart from the three-dimensional acceleration sensor 3111, piezoresistive and heat-detection acceleration sensors are known, and the present invention can be implemented using any of these known methods. Also, in the case where the operation panel 3000 is placed upright in the home position 2000 when powered on, recognition of whether the operation panel is in portrait or landscape direction can be performed by a 3-axis tilt sensor 3113, without relying on the 3D gyro sensor 3112 or the 3D acceleration sensor 3111 described earlier. The techniques for detecting the direction and posture of an apparatus using these various sensors are known, and since the operation panel 3000 can be equipped with any of these techniques in the present invention, a more detailed description is omitted.

The DISPC 3105, in response to the request from the CPU 3101, transfers video data expanded in the RAM 3108 to the LCD 3200, and controls the LCD 3200 to display the video data. The PANELC 3106, in response to a request from the CPU 3101, controls the touch panel 3300 and the button device 3400. Under this control, the position pressed on the touch panel 3300 or a key code corresponding to a button pressed on the button device 3400 is sent back to the CPU 3101. A memory controller 3114, under the control of the CPU 3101, is able to access an external memory 3116 such as an SD memory via an external memory connector 3115, and read out data from the external memory 3116. The memory controller 3114 is able to display the data thus read out on the LCD 3200 via DISPC 3105. The memory controller 3114, under the control of the CPU 3101, is also able to transmit and receive data to and from the main body 1000 via the IEEE 802.11b module 3102.

The power supply controller 3104 is connected to the connector 3500, and receives power from the power supply module 1500 of the main body 1000 when the connector 2200 of the home position 2000 and the connector 3500 are in a contact state. The power supply controller 3104 thereby supplies power to the entire operation panel 3000 while also charging a battery 3211 that is connected to the power supply controller 3104. If power is not being supplied from the power supply module 1500, the power supply controller 3104 supplies power from the battery 3211 to the entire operation panel 3000.

The IEEE 802.11b module 3102, under the control of the CPU 3101, establishes wireless communication with the IEEE 802.11b module 2101 on the home position 2000, and mediates communication with the main body 1000. The irDA module 3103, under the control of the CPU 3101, establishes infrared communication with the irDA module 2102 on the home position 2000, and mediates communication with the main body 1000.

Next, wireless communication serving as the main channel according to the present embodiment will be described.

As mentioned briefly in the description of FIG. 2, in the present embodiment, the wireless communication serving as the main channel is carried out in compliance with the IEEE 802.11b standard, which is known technology. By way of further explanation, in the system of the present embodiment, wireless communication is carried out in infrastructure mode in which the main body 1000 serves as an access point (AP) and the operation panel 3000 serves as a terminal.

The operation panel 3000 is configured such that, in the case where there are a plurality of image forming apparatus main bodies in a coverage range of radio waves output from the operation panel 3000, ESSIDs of the plurality of communicable image forming apparatus main bodies are displayed on the display unit of the operation panel 3000, and the user is able to select one of these as a communication partner, as with existing personal computers.

After establishing communication with the communication partner by association, the operation panel 3000 according to the present embodiment operates as a screen transfer thin client. That is, most of the actual processing and video image generation is executed by the CPU 1101 of the main body 1000. The generated video data is then sent wirelessly from the main body 1000 to the operation panel 3000 using a predetermined protocol. The CPU 3101 of the operation panel 3000, having received this video data, expands the received video data in the RAM 3108, and controls the DISPC 3105 to display an image based on the video data on the LCD 3200.

On the other hand, information related to an operation by the user on the touch panel 3300 or the button device 3400 of the operation panel 3000 is also sent wirelessly from the operation panel 3000 to the main body 1000, using a predetermined protocol. Information related to this operation includes, for example, the position pressed on the touch panel 3300, or a key code corresponding to a button pressed on the button device 3400. The CPU 1101 of the main body 1000, having received the information related to the operation, controls individual operations based on the information sent thereto, updates the video data as necessary, and sends the video data to the operation panel 3000 as described earlier.

As described above, the system according to the present embodiment is a system in which the main body 1000 and the operation panel 3000 can communicate wirelessly.

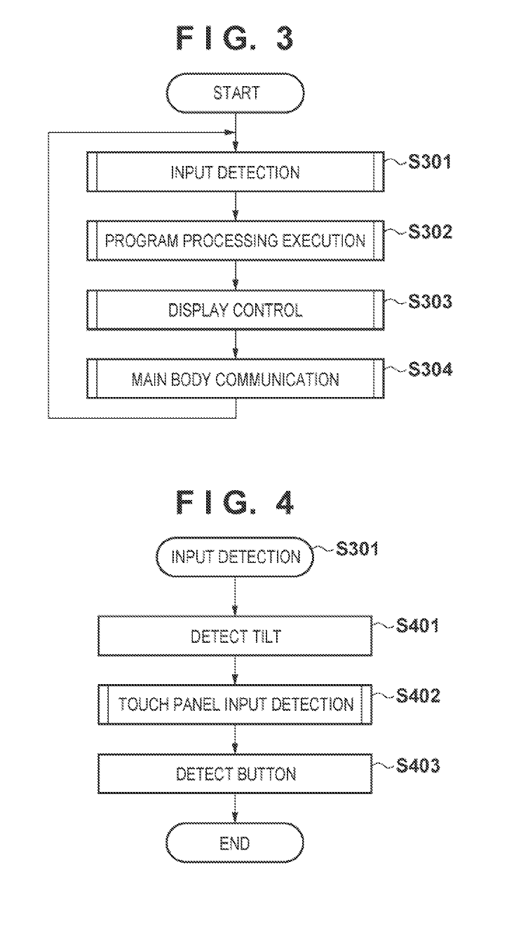

FIG. 3 is a flowchart illustrating processing by the operation panel 3000 according to the present embodiment. A program for executing this processing is stored in the flash ROM 3107, and is executed under the control of the CPU 3101. That is, after the operation panel 3000 has been powered on, the CPU 3101 starts the processing shown in the flowchart of FIG. 3 by executing a program stored in the flash ROM 3107.

First, at S301, the CPU 3101 executes an input detection routine, and performs tilt detection of the operation panel 3000, input detection of the touch panel 3300, key input detection, and the like, based on operations performed on the operation panel 3000 by the user. Next, at S302, the CPU 3101 executes program processing, by executing a program stored in the flash ROM 3017 according to the result detected in the input detection routine of S301. The CPU 3101 executes a display control routine at S303, and performs display control on the LCD 3200 based on the program processing of S302. Also, the CPU 3101 executes the program processing of S302, based on the result detected in the input detection routine of S301, and controls display on the operation panel 3000, based on the result of the program processing. At S304, the CPU 3101 executes communication processing with the main body 1000, and controls transmission and reception of image data, key data and the like with the main body 1000. Control of the main body 1000 is performed using the processing routine for this communication processing.

FIG. 4 is a flowchart illustrating the input detection processing of S301 in FIG. 3 in detail.

At S401, tilt detection and motion detection of the operation panel 3000 are performed. Here the CPU 3101 detects whether the operation panel 300 is in an upright state or a flat state, and whether it is in portrait direction or landscape direction, using data detected by the 3D acceleration sensor 3111, the 3D gyro sensor 3112, and the 3-axis tilt sensor 3113. Further, three-dimensional motion is accurately detected in the front-back, left-right and up-down directions. Next, at S402, a touch panel input detection routine is executed, and input to the touch panel 3300 is detected. Here, one-point input to the touch panel 3300, simultaneous multi-point input, and movement between input points can be detected. Next, the processing advances to S403, and the CPU 3101 executes a button detection routine, and detects whether the button device 3400 provided in the operation panel 3000 has been pressed. If the button device 3400 has been pressed, a key code corresponding to the button that was pressed is notified to the CPU 3101 via the PANELC 3106.

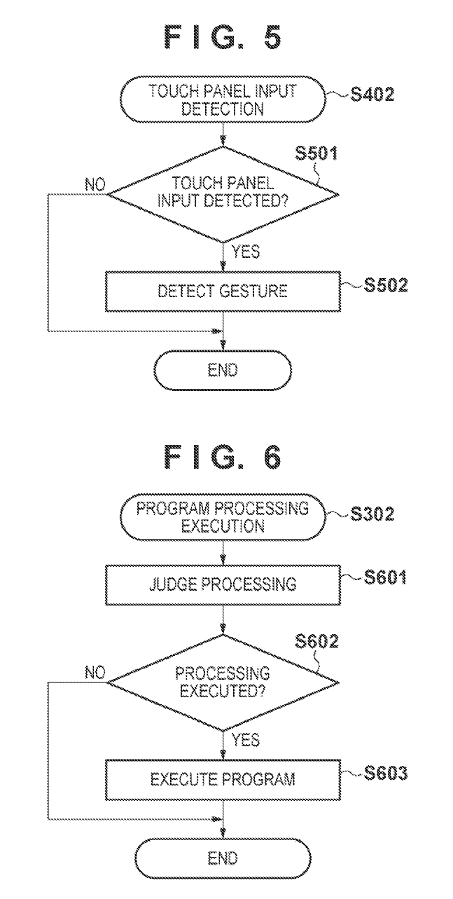

FIG. 5 is a flowchart illustrating the touch panel input detection processing of S402 in FIG. 4 in detail.

First, at S501, the CPU 3101 detects whether the touch panel 3300 has been pressed. When input to the touch panel 3300 is detected at S501, the processing advances to S502, and gesture detection is executed. This gesture detection of S502 is for detecting the processing content from the input operation on the touch panel 3300, and input operations are detected as follows:

(A) If only one point is touched: “select” or “execute”
(B) If moved while touching one point: “move”
(C) If the distance between two points is decreased while touching two points: “reduce”
(D) If the distance between two points is increased while touching two points: “enlarge”
(E) If rotated while touching two points: “rotate”

It should be apparent that processing other than the above can be accommodated by changing the program.

The program processing of S302 in FIG. 3 is executed according to the gesture detection result of S502, and data to be displayed on the LCD 3200 is controlled by controlling the PANELC 3106. On the other hand, if, at S501, pressing of the touch panel 3300 is not detected, NO is selected, and the processing is ended.

FIG. 6 is a flowchart illustrating the program processing of S302 in FIG. 3 in detail.

At S601 of FIG. 6, judgment processing for judging whether to execute the program processing (enable/disable the program processing) is performed, based on the result detected in the input detection routine of S301 in FIG. 3. For example, if it is judged that there is little change in the tilt of the operation panel 3000, the image data is not changed. Also, if an area other than a mark image (icon) indicating program execution displayed on the LCD 3200 is touched, it is judged to be an invalid input, and program processing is not performed. When, at S602, it is judged to execute program processing, the processing advances to S603, where a program is executed according to the input detection processing in S301. Note that if, at S602, it is judged not to execute processing, the processing is ended without performing any processing.

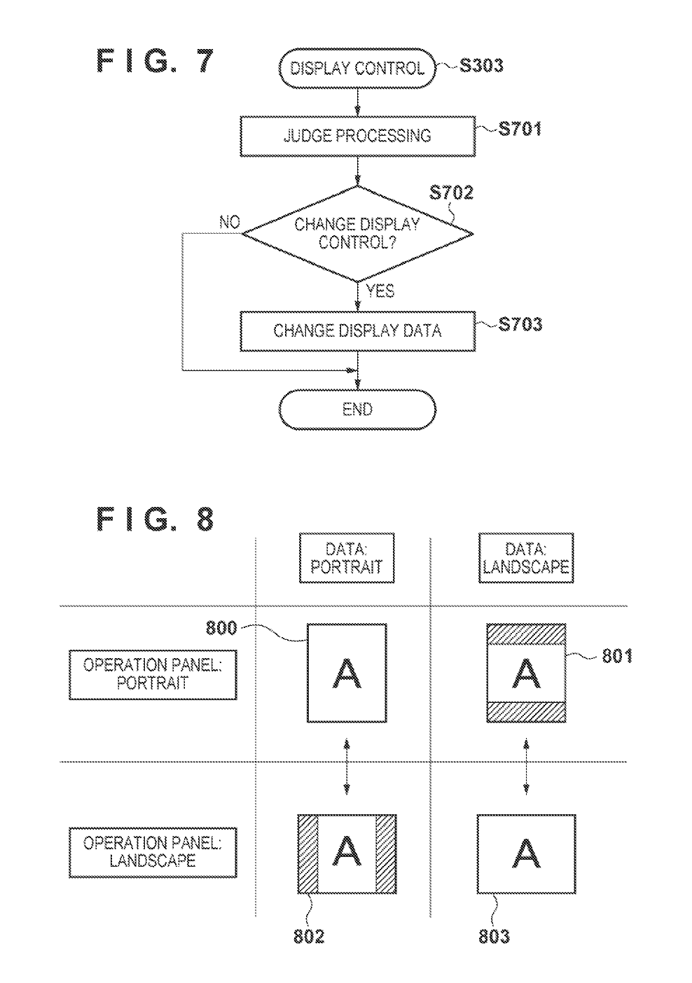

FIG. 7 is a flowchart illustrating the display control processing of S303 in FIG. 3 in detail.

At S701, it is judged whether to change the display control of the LCD 3200, based on the detection result of the input detection routine in S301 of FIG. 3, and the execution result of the program processing in S302. If, as a result of the judgment in S701, it is judged at S702 to change the display control, the processing advances to S703, where processing to change the display data is executed. At S703, the CPU 3101 judges whether to change the display data being displayed on the LCD 3200, as the change in display control. In the case of changing the display data, the data displayed on the LCD 3200 is controlled, according to the detection result of the gesture detection processing in S502.

FIG. 10 is a diagram showing a basic screen of the operation panel 3000 according to the present embodiment.

Various functions are displayed on the LCD 3200. Position information is input to the PANELC 3106 via the touch panel 3300 on the LCD 3200 when the user touches the screen. The CPU 3101 compares display data on the LCD 3200 and the data input via the touch panel 3300, and judges whether a function has been designated by the user.

In FIG. 10, a mark (hereinafter, icon) 101 is used for instructing a copy operation, an icon 102 is used for instructing a scan operation, and an icon 103 is used for instructing file selection. When the user presses any of these icons, a program corresponding to the processing is started and executed. For example, when the Copy icon 101 is pressed, a screen for setting copying by the main body 1000 is displayed. The user can configure various settings for performing copying, in accordance with the displayed screen, and execute copy processing on the main body 1000.

When the user presses the File icon 103, a file selection screen is displayed, and a program for displaying the contents of the selected file on the LCD 3200 is executed. The files that can be selected here include image files stored in the HDD 1400, and data (files) on the personal computer 9000 connected via the LAN 8000. The present embodiment will describe the case where data stored in a memory 3116 inserted into the memory connector 3115 of the operation panel 3000 is to be used. When a memory 3116 such as an SD card or a USB memory is mounted in the connector 3115 by the user, the mounted memory 3116 is recognized by the CPU 3101 via the memory controller 3114. The CPU 3101 thereby enters a state of being able to read out data from the memory 3116, and write data to the memory 3116. When data on the memory 3116 has been selected by the user, the contents of the selected data are displayed on the LCD 3200.

FIG. 8 is a diagram showing example combinations of the vertical/horizontal direction of the operation panel 3000 and the vertical/horizontal layout of a single page according to the present embodiment. In FIG. 8, one full page of document data is displayed on the operation panel 3000. The document data displayed here is data stored in the HDD 1400, data on the PC 9000 data connected via the LAN 8000, or data stored in the memory 3116 inserted into the connector 3115, that is displayed when the File icon 103 is selected on the screen in FIG. 10. Further, the data may be image data read by the scanner 1300 (e.g., preview image). In FIG. 8, four display examples are shown by combining the direction of the operation panel 3000 (portrait (vertical), landscape (horizontal)) and the direction of the displayed page (portrait, landscape). In FIG. 8, in the case of 803 and 800, the size of the displayed page coincides with the screen size of the display unit (LCD 3200).

800 in FIG. 8 shows the case where the direction of the operation panel 3000 is vertical and the display page is vertical. 801 shows the case where the direction of the operation panel 3000 is vertical, and the display page is horizontal. Further, the case where the direction of the operation panel 3000 is horizontal and the display page is vertical is displayed as shown by 802, and the case where the direction of the operation panel 3000 is horizontal and the display page is horizontal is displayed as shown by 803.

Thus, the case where the display data and the operation panel 3000 are both vertical will be displayed as shown by 800. When the direction of the operation panel 3000 is changed to be horizontal from this state, the page is reduced and the full page is displayed as shown by 802. When the direction of the operation panel 3000 is then changed back to be vertical, display returns to that shown by 800.

Similarly, in the case where the display data and the operation panel 3000 are both horizontal, the page is displayed to fit the full display screen of the operation panel 3000, as shown by 803. When the direction of the operation panel 3000 is changed in this state to be vertical, the page is displayed as shown by 801 after being reduced since the full page cannot be displayed at its current magnification.

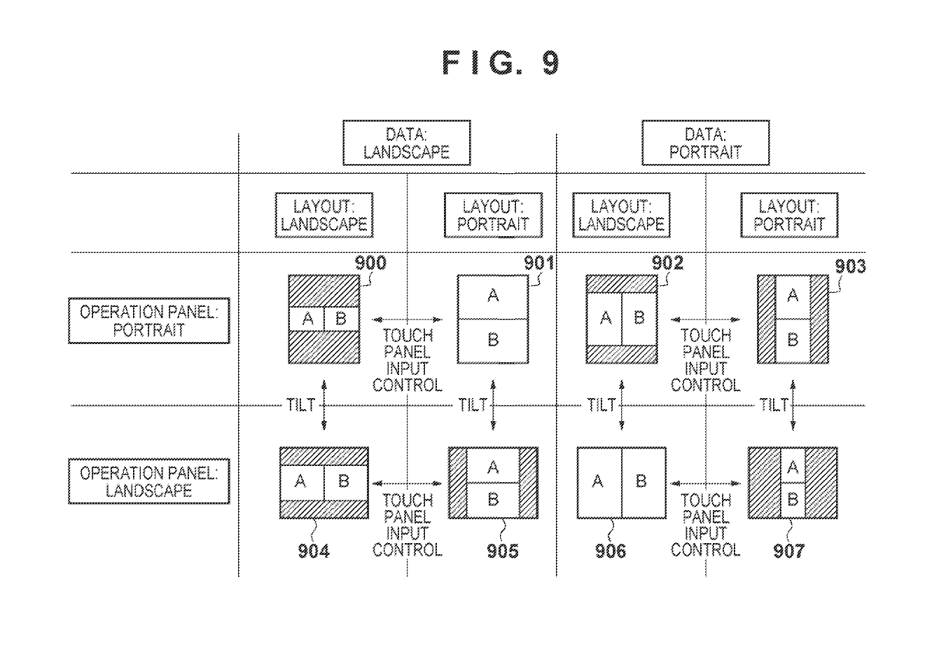

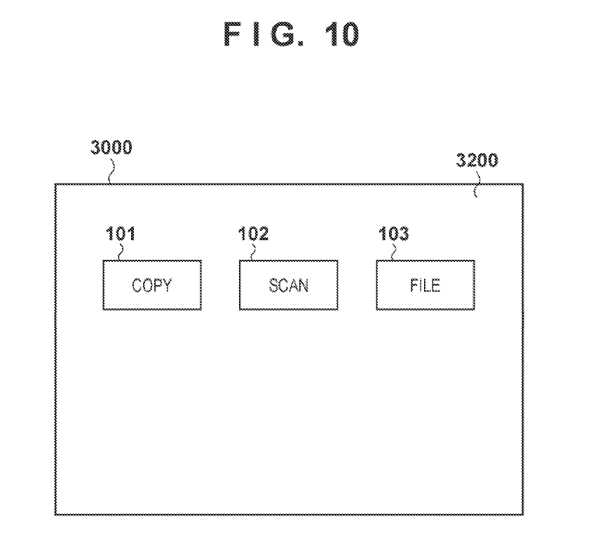

FIG. 9 is a diagram showing examples of layouts in the case where the images of two pages (2in1) are displayed on the panel LCD 3200 of the operation panel 3000. Here, as shown in FIG. 9, there are eight patterns for laying out two pages on a single sheet. In FIGS. 9, 900 to 903 show cases where the direction of the operation panel 3000 is vertical, and 904 to 907 show cases where the direction of the operation panel 3000 is horizontal. 900, 901, 904 and 905 show cases where the display of a single page is horizontal, and 902, 903, 906 and 907 show cases where display of a single page is vertical. Also, 901, 903, 905 and 907 show cases where the two pages are laid out one on top of the other, and 900, 902, 904 and 906 show cases where the two pages are laid out one beside the other.

First, when the operation panel 3000 is directed vertically in the case where two pages are displayed on the operation panel 300 with the layout of the two pages being vertical and page display being horizontal, the page data will be laid out and displayed one on top of the other as shown by 901. In this case, the display size of the two pages fits the size of the display unit (LCD 3200) of the operation panel 3000. When the direction of the operation panel 3000 is changed in this state to be horizontal, the display will change to the layout shown by 905.

When the A or B portion of the touch panel 3300 is pressed and moved from the state shown by 905, display is changed to a layout in which the two pages are arranged one beside the other, as shown by 904. When the direction of the operation panel 3000 is changed in this state to be vertical, the display is changed as shown by 900.

Similarly, when, in the case where page display is vertical, the operation panel 3000 is directed horizontally in the case where the two pages are laid out and displayed one beside the other on the operation panel 3000, the page data will be arranged and displayed one beside the other as shown by 906. In this case, the display size of the two pages fits the size of the display unit (LCD 3200) of the operation panel 3000. When the direction of the operation panel 3000 is changed to be vertical from the state shown by 906, the display will be as shown by 902. Here, the pages remain laid out one beside the other, and the display data of each page is displayed after having been reduced, so that the full two pages are displayed. When page A or B is moved through operating the touch panel 3300 in the state of 902, the layout can be changed so that the pages are one above the other as shown by 903. When the direction of the operation panel 3000 is changed in this state to be horizontal, the layout remains with the pages one above the other, and the display data of each page is displayed after having been reduced, so that the full two pages are displayed, as shown by 907. Changing the display from 907 to 906 is carried out by moving page A or B through operating the touch panel 3300.

Note that, the image of each page, when laying out and displaying the images of a plurality of pages on a single page, is displayed as a thumbnail image corresponding to the size of the single page. The direction and sequence of each image can thus be comprehended as an image that will actually be printed on a single page, and errors involving the page settings for printing are less likely to occur.

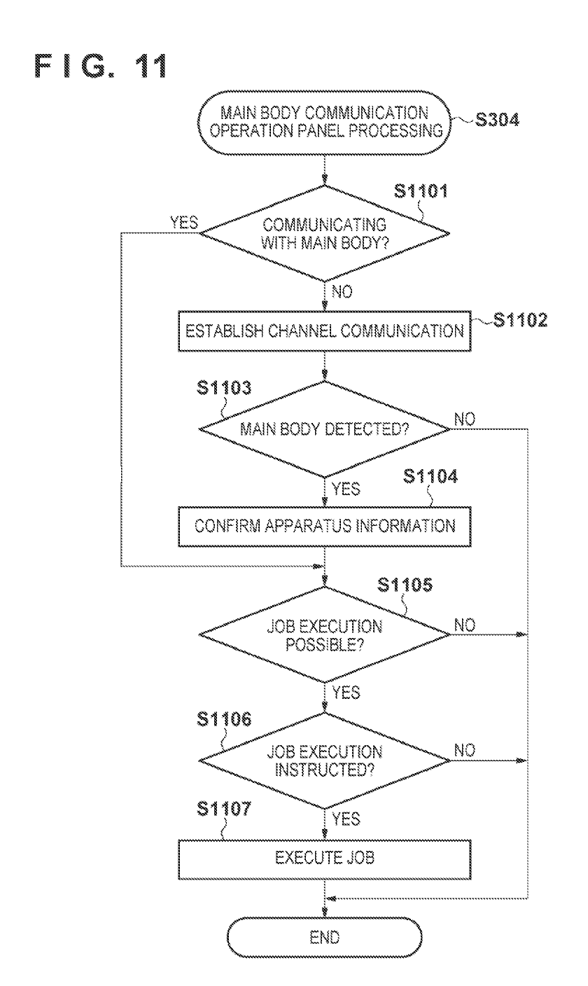

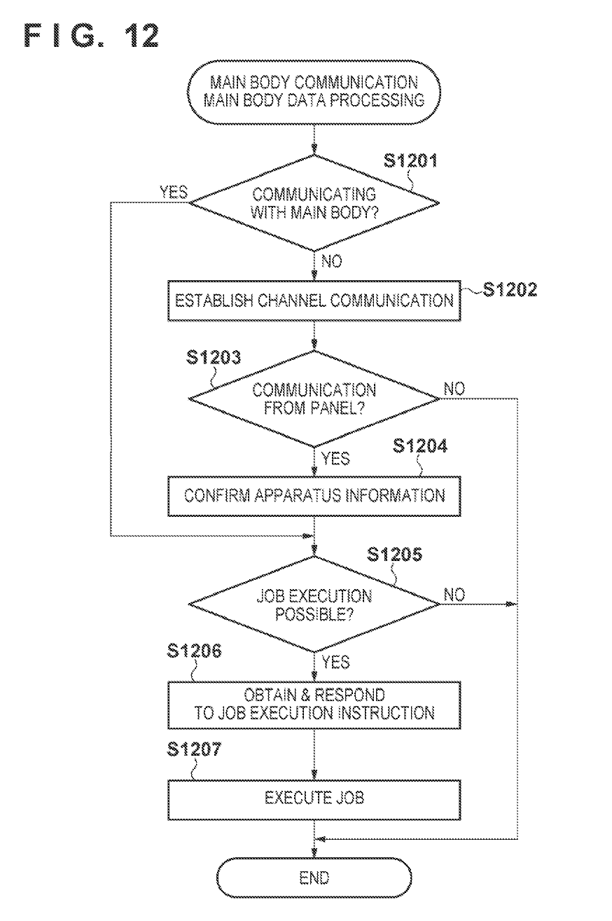

FIG. 11 is a flowchart illustrating the communication processing of S304 in FIG. 3 in detail. FIG. 12 is a flowchart showing data processing by the image forming apparatus main body 1000 of the present embodiment. Further, FIG. 13 is a sequence diagram showing data processing between the operation panel 3000 and the main body 1000.

First, processing by the operation panel 3000 will be described using FIG. 11 and FIG. 13. Note that the steps of the flowchart in FIG. 11 are realized by the CPU 3101 of the operation panel 3000 reading out and executing a control program recorded in the flash ROM 3107.

First, at S1101, the CPU 3101 of the operation panel 3000 determines the wireless communication state of the main channel (communication state determination processing), and determine whether wireless communication is being performed with the main body 1000. If it is determined that wireless communication serving as the main channel is not being performed, the processing advances to S1102, and a request for establishing main channel communication with the main body 1000 (SQ1 in FIG. 13) is transmitted to the apparatus main body. Note that in the case where there are a plurality of image forming apparatus main bodies in a coverage range of the radio waves of the main channel, ESSIDs of the plurality of main bodies that are communicable with the operation panel 3000 are displayed. Thus, the user is prompted to select one of the displayed ESSIDs, and the abovementioned request is transmitted to the main body of the selected ESSID. The processing then advances to S1103, where the CPU 3101 determines whether the main body 1000 was detected, depending on whether or not a response indicating that communication is permitted has been received from the main body 1000. The CPU 3101 repeats S1102 for a fixed period of time, until the main body 1000 is detected. If, at S1103, it is determined that the main body 1000 was detected, the CPU 3101 establishes main channel communication with the main body 1000 and advances the processing to S1104.

At S1104, the CPU 3101 confirms apparatus information such as the apparatus ID and available functions of the main body 1000 (SQ2 in FIG. 13). Specifically, the CPU 3101 transmits an apparatus information confirmation request (request for confirming apparatus information such as the apparatus ID and available functions of the main body 1000) to the main body 1000, and receives the apparatus information from the main body 1000.

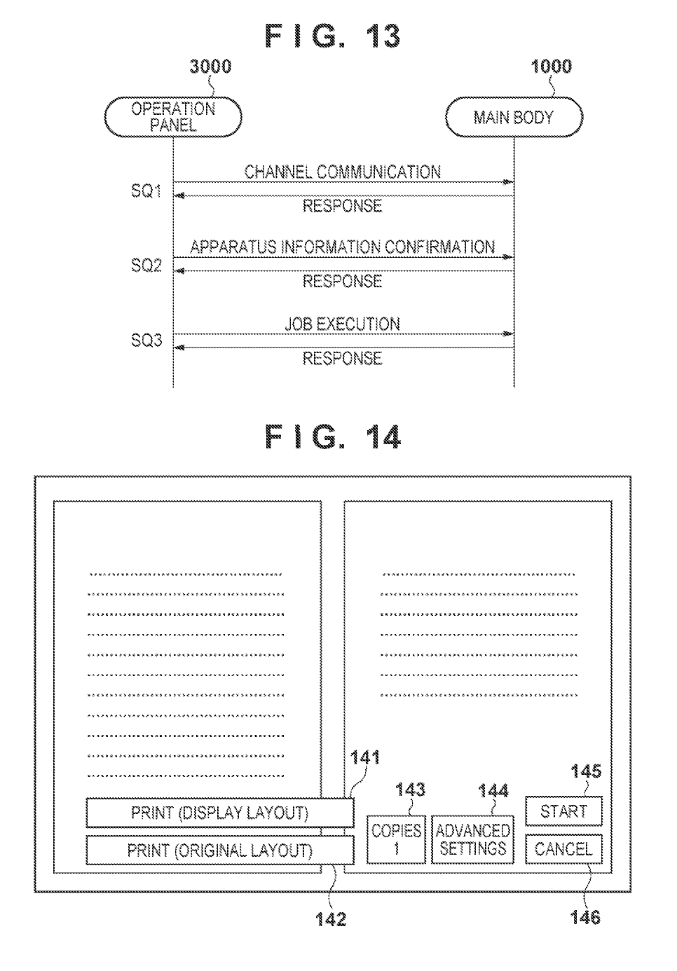

The CPU 3101 advances the processing to S1105 after receiving the apparatus information. Also, if, at S1101, it is determined that communication is being performed with the main body 1000 via wireless communication serving as the main channel, the processing advances to S1105. At S1105, it is judged, from the information obtained from the main body 1000, whether job execution is possible in the main body. If it is judged that job execution is possible, the processing advances to S1106, where the operation panel 3000 waits for a job execution instruction, advances to S1107 when a job execution instruction is received, and executes the job (SQ3 in FIG. 13). Here, data transfer is performed from the operation panel 3000 to the main body 1000 as necessary. When it is judged from the information obtained from the main body 1000 that job execution is not possible, execution of a job is not accepted until it is judged that job execution is possible. Further, in the case where layout designation is performed once it has been determined at S1105 that job execution is possible, a print instruction screen is displayed as shown in FIG. 14, in the display control routine of S303.

Next, data processing by the image forming apparatus main body 1000 will be described with reference to FIG. 12 and FIG. 13.

The steps in the flowchart of FIG. 12 are realized by the CPU 1101 of the main body 1000 reading out and executing a control program recorded in the flash ROM 1102.

First, at S1201, the CPU 1101 of the main body 1000 determines the wireless communication state of the main channel (communication state determination processing), and determines whether wireless communication is being performed with the operation panel 3000. If it is determined that communication using wireless communication serving as the main channel is not being performed, the CPU 1101 advances the processing to S1202. At S1202, the CPU 1101 broadcasts information including its ESSID to notify the ESSID to the operation panel 3000, as processing for performing main channel communication, and advances the processing to S1203. At S1203, the CPU 1101 determines whether the operation panel 3000 has been detected depending on whether the above-mentioned request (SQ1 in FIG. 13) has been received from the operation panel 3000, and repeats the processing of S1202 for a fixed period until the operation panel 3000 is detected. When, at S1203, it is determined that the operation panel 3000 has been detected, the CPU 1101 transmits a response indicating that communication is permitted to the operation panel 3000 to establish main channel communication with the operation panel 3000. The processing then advances to S1204, where the CPU 1101 performs apparatus information confirmation processing (SQ2 in FIG. 13). Specifically, the CPU 1101, on receipt of an apparatus information confirmation request transmitted from the operation panel 3000 (request for confirming apparatus information such as the apparatus ID and available functions of the main body 1000), obtains apparatus information held in the flash ROM 1102, and transmits the obtained apparatus information to the operation panel 3000.

The CPU 1101 advances the processing to S1205, after transmitting the apparatus information. Also, if, at S1201, it is determined that communication is being performed with the operation panel 3000 via wireless communication serving as the main channel, the CPU 1101 advances the processing directly to S1205. At S1205, it is determined whether a job execution instruction has been received from the operation panel 3000. If it determined that a job execution instruction has been received, the processing advances to S1206, where the contents of the job execution instruction and data required for executing the job are received from the operation panel 3000, and a response confirming receipt is returned. Then at S1207, the CPU 1101 executes the job in the main body 1000, in accordance with the execution instruction of the received job (SQ3 FIG. 13). In this job execution, the direction of the operation panel 3000, the direction of the data, and the page layout information are sent from the operation panel 3000 to the main body 1000, and the CPU 1101 of the main body 1000 calculates a detailed layout for the print sheet and executes printing. Alternatively, the operation panel 3000 may obtain print sheet information of the main body 1000, calculate a more detailed layout for the print sheet, from the direction of the operation panel 3000, the direction of the data, the data size, and the page layout information, and send the calculated layout to the main body 1000. Both methods result in the display layout of the operation panel 3000 and the print layout of the main body 1000 being the same.

FIG. 14 shows an example print execution screen displayed on the display unit (LCD 3200) of the operation panel.

Once channel communication is established between the operation panel 3000 and the main body 1000, icons 141 to 146 are displayed on the screen of the LCD 3200 of the operation panel 3000. Here, when any of these icons is pressed, processing corresponding to the pressed icon is executed.

A Print (Display Layout) icon 141 corresponds to processing for printing with the layout displayed on the operation panel 3000. If the user presses the icon 141, subsequent pages that have not been displayed at that point will also be printed with a similar layout. This processing will be discussed later with reference to the flowchart of FIG. 18. A Print (Original Layout) icon 142 corresponds to processing for printing in accordance with the original layout of the display data. Further, a Copies icon 143 is used to designate the number of copies. An Advanced Settings icon 144 is used in the case of setting other detailed items, and when touched, the display screen of the LCD 3200 moves to an advanced settings screen. Usually, with printing using the display layout (corresponding to icon 141), printing is executed after selecting the default sheet (e.g., A4 sheet). Reference numeral 145 denotes a Start button for instructing the start of printing, and 146 denotes a Cancel button for canceling setting on the screen in FIG. 14, and for returning display to the original screen (e.g., FIG. 10).

According to Embodiment 1 as described above, an image forming apparatus main body can be instructed so as to execute printing of data such as document data consisting of a plurality of pages, with a layout set using a detachable operation panel. Even in the case where a print instruction is given after changing the layout of data consisting of a plurality of pages to be printed by rotating the operation panel or by touching with a finger or the like, printing in accordance with the changed layout can be executed on the image forming apparatus main body.

Embodiment 2

In the Embodiment 1 mentioned above, print processing based on the layout display on the operation panel 3000 was described. In contrast, in Embodiment 2, PDF processing based on extended layout display and print extension processing will be described. Note that since the hardware configurations of an image forming apparatus 1000, an operation panel 3000 and the like according to Embodiment 2 are the same as the abovementioned Embodiment 1, description thereof is omitted.

FIG. 15, similarly to FIG. 9, is a diagram showing examples of layouts in the case where two pages are displayed on the operation panel 3000. Portions in common with FIG. 9 are shown with the same reference signs.

Even in Embodiment 2, page data to be displayed can be selected and changed to a layout intended by the user, by the direction of the page data, the direction of the operation panel 3000 and the control of the touch panel 3300.

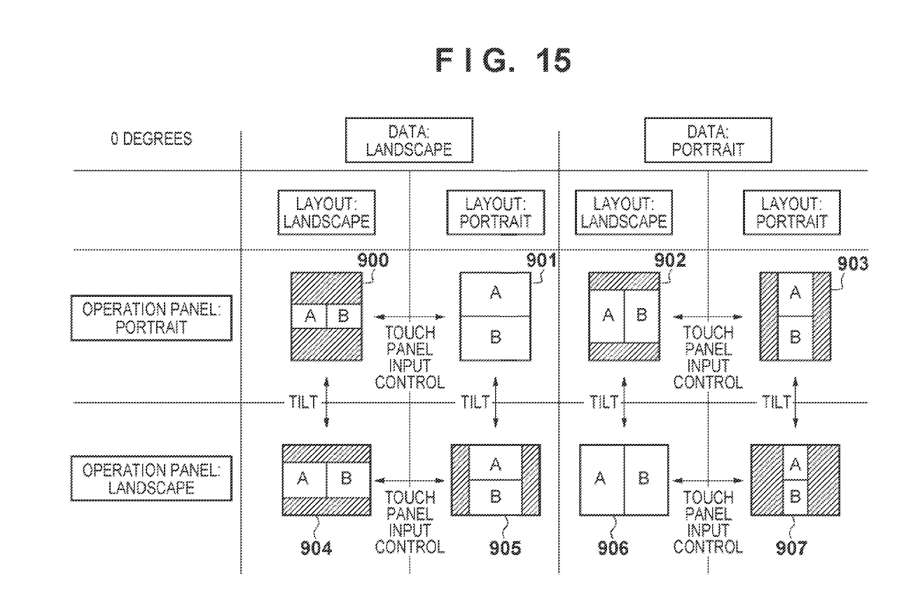

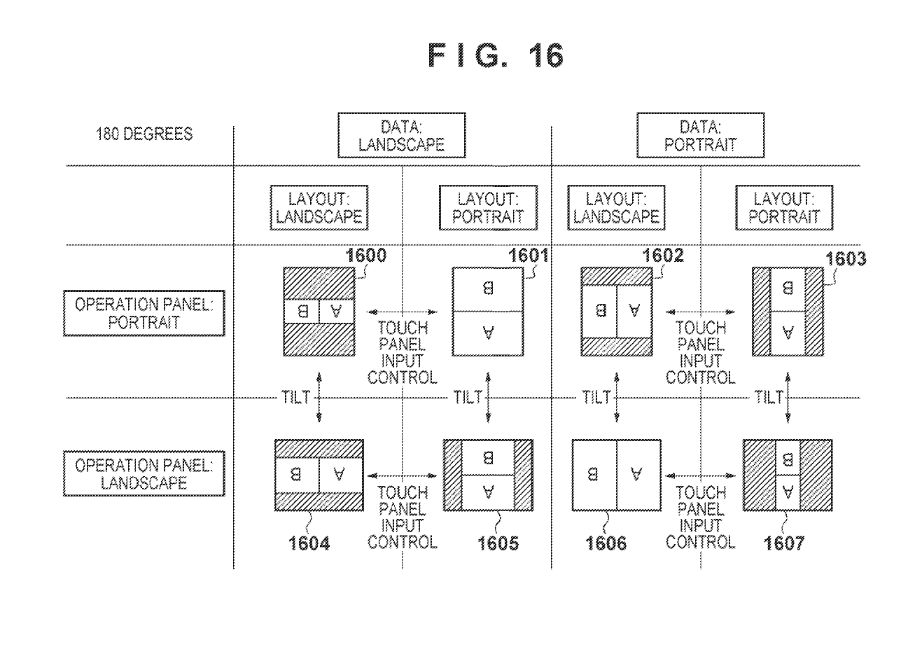

FIG. 16 is a diagram in which the layout display of FIG. 15 has been rotated 180 degrees.

In the case of, for instance, converting a read original image to PDF data, with the conventional example there may be a case in which PDF conversion is performed with an unexpected layout, depending on the direction of the original to be read when reading the original image. In contrast, in Embodiment 2, the page after having actually been converted to PDF data is laid out and displayed, using a large-screen LCD 3200 and reduced images. This allows PDF conversion with a desired layout to be reliably performed.

The images shown by 1600 to 1607 in FIG. 16 are the result of displaying 900 to 907 in FIG. 15 after each has been rotated 180 degrees using touch panel control. Control of each layout is similar to that described in the aforementioned Embodiment 1.

In the case of normal print processing, the result of printing 900 in FIG. 15 and the result of printing 1600 in FIG. 16 will be the same, because the printed sheet can be displayed after being rotated. However, processing such as PDF conversion, stapling printed sheets, and punching for opening holes, being dependent on the relationship between the printed sheet and the post-processing (stapling, punching) position, do not produce the same processing result for the rotated and un-rotated pages (images). In particular, if the position at which stapling or punching is performed on a sheet does not coincide with the direction in which the actual printed image will be read, the sheet after printing will be very difficult to handle. Also, in the case where image data corresponding to a read image is converted to PDF data, and the layout of the PDF data does not coincide with the direction in which the image will actually be viewed, other correction processing such as rotation of the layout will be required.

In Embodiment 2, layout setting errors are forestalled, by aligning the direction of the operation panel 3000 with the direction of the sheets that will actually be used, displaying the page data with the layout desired in this state, and selecting the desired layout.

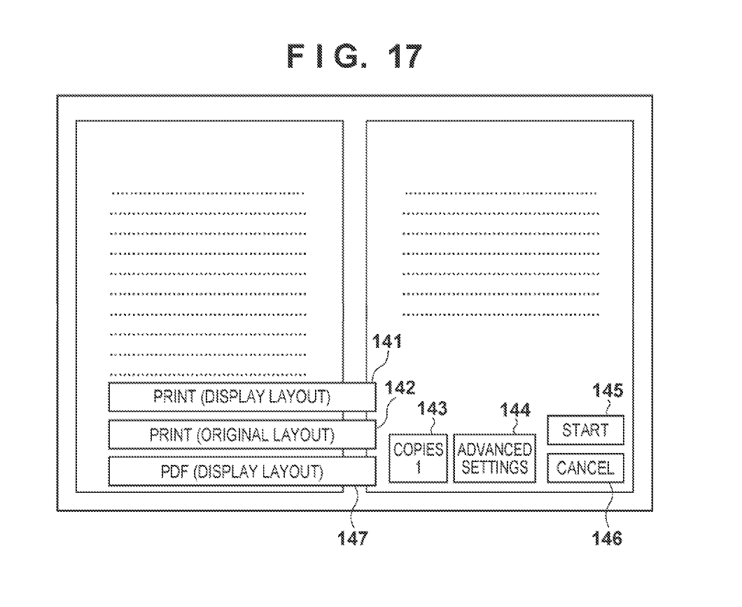

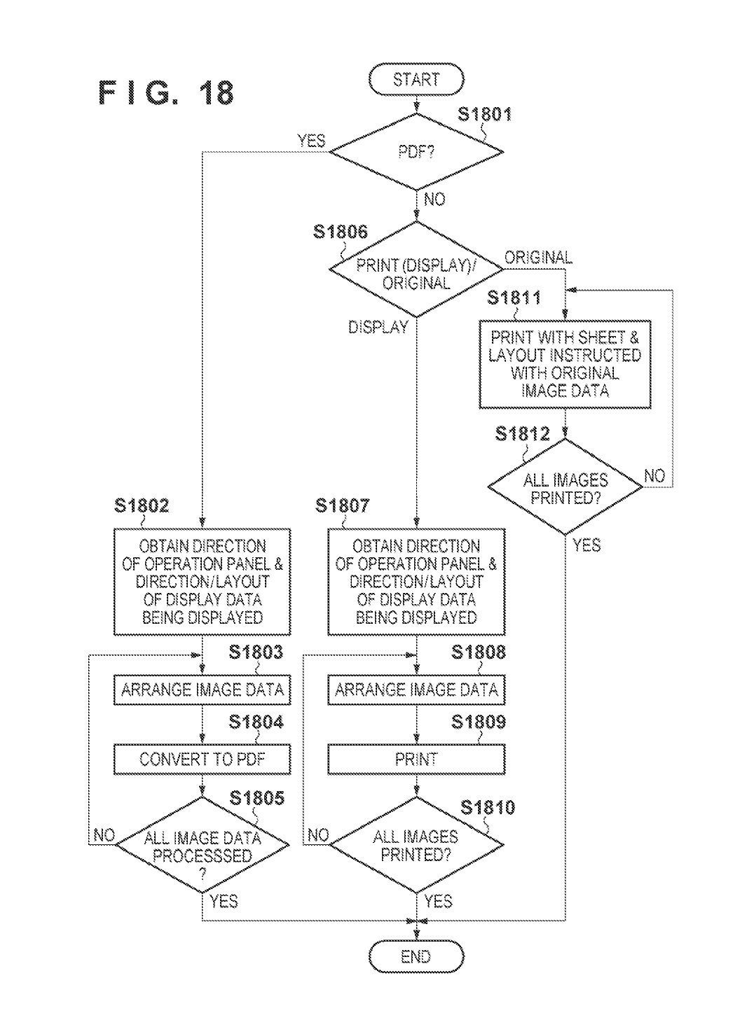

FIG. 17 is a diagram showing an example print execution screen displayed on the LCD 3200 of the operation panel 3000 according to Embodiment 2. Here, portions in common with FIG. 14 are shown with the same reference signs.

When channel communication between the operation panel 3000 and the main body 1000 is established, icons 141 to 147 are displayed on the screen, as shown in FIG. 17. The icons 141 to 146 are similar to those described in FIG. 14. By pressing any of these icons, processing corresponding to the pressed icon is performed.

A PDF (Display Layout) icon 147 corresponds to processing for creating PDF data with the layout displayed on the operation panel 3000. Also, settings for print extension processing such as stapling and punching can be configured using an advanced settings screen displayed by pressing an Advanced Settings icon 144.

While the layout was described with examples in which the images of two pages are laid out in a single page, the present invention is not limited thereto, and can be similarly implemented in all cases where the images of N pages (where N>1) are laid out on a single page.

Also, as an example of virtual printing, processing for converting image (document) data to PDF format was described as Embodiment 2, but the format of image (document) data after page layout is not limited to PDF, and the present invention can also be implemented with another format such as TIFF or JPEG.

According to Embodiment 2 as described above, the image forming apparatus main body can be instructed so as to create PDF data, with a layout set using a detachable operation panel. Also, the user is able to create PDF data conforming to actual use by rotating the image to the direction in which the PDF data will actually be viewed, and changing the layout by touching with a finger or the like in the rotated state.

FIG. 18 is a flowchart illustrating processing by the image forming apparatus main body 1000 according to Embodiments 1 and 2. This processing is achieved by the CPU 1101 executing a control program installed on the HDD 1400 and expanded in RAM or a control program of the flash ROM 1102. This processing is started by a Start button 145 in FIG. 14 or FIG. 17 being touched, and the start of printing or the start of PDF conversion being notified from the operation panel 3000 to the main body 1000.

First, at S1801, the CPU 1101 determines whether PDF (display layout) has been designated. If it is determined that PDF (display layout) has been designated, the processing advances to S1802, where the direction of the operation panel 3000 and the direction and layout of the display data displayed on the operation panel 3000 are obtained from the operation panel 3000. Next, the processing advances to S1803, where the direction and layout of the display data arranged on a single page is determined in accordance with the direction of the operation panel 3000 and the direction and layout of the display data displayed on the operation panel 3000, and then the image data is arranged on the single page. Here, original image data read by the scanner 1300, or document data or image data input from the PC 9000 is targeted for processing. The processing then advances to S1804, where the image data arranged at S1803 is converted to PDF data. At S1805, it is checked whether processing of all image data, such as reading of all original images, for example, has ended, and if not, the processing returns to S1803, where the next image data is processed. Note that, at this time, at S1803, image data is arranged in accordance with the direction of the operation panel 3000 and the direction and layout of the display data displayed on the operation panel 3000 obtained at S1802. Pages subsequent to this page will also be subject to PDF conversion in accordance with the layout of the operation panel 3000. When processing for all image data has thus ended, this processing ends.

If, at S1801, PDF conversion is not instructed, the processing advances to S1806, where it is judged whether printing in accordance with the layout displayed on the operation panel 3000 or printing in accordance with the layout (original layout) of the original document or the like is instructed. When print (display layout) (icon 141) is designated in FIG. 14 or FIG. 17, the processing advances to S1807, where the direction of the operation panel 3000 and the direction and layout of the display data displayed on the operation panel 3000 is obtained. Next, the processing advances to S1808, where the direction and layout of the image data to be arranged on a single page is determined, in accordance with the direction of the operation panel 3000 and the direction and layout of the display data displayed on the operation panel 3000, and the image data is arranged on a single page. Here, original image data read by the scanner 1300, document data or image data input from the PC 9000 is targeted for processing. Alternatively, document data or image data stored in an HDD 1400, or document data or image data stored in a memory 3116 that is inserted into a memory connector 3115 may be targeted for processing. The processing then advances to S1809, where printing in accordance with the image data arranged at S1808 is performed. At S1810, it is checked whether print processing of all image data has ended, and if not ended, the processing returns to S1808, and the next image data is processed. Note that, at this time, at S1808, the image data is arranged in accordance with the direction of the operation panel 3000 and the direction and layout of the display data displayed on the operation panel 3000 that were obtained at S1807. Pages subsequent to this page will also be printed in accordance with the layout of the operation panel 3000. When print processing of all image data has thus ended, this processing is ended.

When, at S1806, printing with the layout of the original document is instructed, the processing advances to S1811, where printing is performed in accordance with the direction, layout and the like of the printing set for the document data or image data, regardless of the display on the operation panel 3000. At S1812, it is determined whether print processing of all image data has ended. If not ended, the processing returns to S1811, and if ended, this processing is ended.

Note that in FIG. 18, the case of printing with the layout of the original document was described, but a command for conversion to PDF data with the layout of the original document may be added.

According to Embodiment 1 and 2, print processing or creation of PDF data with the direction of data and the layout set using an operation panel can be performed, and those settings can also be applied to subsequent document data to perform printing or create PDF data.

According to the embodiments as described above, the layout of display data can be changed by using the operation panel 3000, which is capable communicating wirelessly with the main body 1000 and has a tilt sensor, according to the tilt of the operation panel 3000 and the instructions input on the touch panel 3300. Also, the main body 1000 can be instructed to perform print processing or creation of PDF data with the layout thus displayed on the operation panel 3000. Operability for the user can thereby be enhanced.

### Other Embodiments

Aspects of the present invention can also be realized by a computer of a system or apparatus (or devices such as a the CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the present invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-230104, filed Oct. 12, 2010, which is hereby incorporated by reference herein in its entirety.

1. An image processing apparatus comprising:
a communicating unit that communicates with an operation panel provided with a display unit;
an obtaining unit that obtains, from the operation panel, information indicating a display layout for data that is displayed on the display unit, the display layout being set by a direction of the operation panel;
a generating unit that generates image data in accordance with the display layout, based on the information obtained by said obtaining unit; and
an outputting unit that outputs the image data generated by said generating unit.

2. The image processing apparatus according to claim 1, wherein the display layout includes a layout in which images of a plurality of pages are arranged on a single sheet.

3. The image processing apparatus according to claim 1, wherein said outputting unit performs print processing in accordance with the image data.

4. The image processing apparatus according to claim 1, wherein said outputting unit creates PDF data in accordance with the image data.

5. The image processing apparatus according to claim 1, wherein said outputting unit outputs the image data, in accordance with the display layout of the data corresponding to the generated image data.

6. The image processing apparatus according to claim 1, wherein the operation panel comprises at least a tilt sensor and a three-dimensional acceleration sensor, and changes the display layout of the data displayed on the display unit, according to a direction and a tilt of the operation panel, which are detected by the tilt sensor and the three-dimensional acceleration sensor.

7. The image processing apparatus according to claim 6, wherein the operation panel further comprises a touch panel, and changes the display layout of the data displayed on the display unit according to user operation on the touch panel.

8. A control method for controlling an image processing apparatus that communicates with an operation panel provided with a display unit, comprising the steps of:
obtaining, from the operation panel, information indicating a display layout for data that is displayed on the display unit, the display layout being set by a direction of the operation panel;
generating image data in accordance with the display layout, based on the obtained information; and
outputting the generated image data.

9. A non-transitory computer-readable storage medium which stores a program for causing a computer to execute a control method for controlling an image processing apparatus that communicates with an operation panel provided with a display unit, the program causing the computer to function as an image processing apparatus comprising:
an obtaining unit that obtains, from the operation panel, information indicating a display layout for data that is displayed on the display unit, the display layout being set by a direction of the operation panel;
a generating unit that generates image data in accordance with the display layout, based on the information obtained by the obtaining unit; and
an outputting unit that outputs the image data generated by the generating unit.
